(19) United States
(12) Patent Application Publication
(10) Pub. No.: US 2020/0195752 A1
(43) Pub. Date: Jun. 18, 2020

(54) SYSTEM AND METHOD FOR TRANSMITTING VALUE

(71) Applicant: GrailPay Holdings Inc., Sarasota, FL (US)

(72) Inventors: Evangelos P. Kostorizos, Lexington, MA (US); William R. Messina, Sarasota, FL (US)

(21) Appl. No.: 16/714,466

(22) Filed: Dec. 13, 2019

Related U.S. Application Data
(60) Provisional application No. 62/779,061, filed on Dec. 13, 2018.
(60) Provisional application No. 62/808,678, filed on Feb. 21, 2019.

(51) Int. Cl. H04L 29/08; H04L 12/751; G06Q 50/00; G06Q 20/02; H04L 29/06; H04L 12/741

(52) U.S. Cl. CPC H04L 67/327; H04L 45/02; H04L 45/745; G06Q 20/027; H04L 67/42; G06Q 50/01

(57) ABSTRACT

Methods and/or systems that establishes a scale-free unified theory for combining computer networks, payment networks, and social networks into as single, comprehensive model that incorporates pre-existing networks into an automated engine for establishing, maintaining, and controlling a self-sustaining, failure-tolerant environment that operates at peak efficiency.

### RELATED APPLICATIONS

This application claims the benefit of U.S. Provisional Application Ser. No. 62/779,061, filed Dec. 13, 2018, entitled SYSTEM AND METHOD FOR TRANSMITTING VALUE, the entire disclosure of which is herein incorporated by reference. This application also claims the benefit of U.S. Provisional Application Ser. No. 62/808,678, filed Feb. 21, 2019, entitled SYSTEM AND METHOD FOR TRANSMITTING VALUE, the entire disclosure of which is herein incorporated by reference.

### FIELD OF THE INVENTION

The present application related to systems and methods for transmitting value, in particular to systems and methods for using mass values in a network of clients.

### BACKGROUND OF THE INVENTION

On the front line of a competitive environment, a major technological problem associated with retail has been the inefficiencies associated with accepting payment. As cash was replaced with credit cards, the cost of taking payment went from near zero, to between one and two percent. At first, the only reasons a retailer tolerated this was the customer convenience (not having to carry cash or a check book), and the retailer convenience (not having a check bounce). Years of marketing and cheap credit shifted Americans away from cash and checks, and the average cost of convenience grew. Several decades later, in a retail business with a tight profit margin, the retailer will often see the credit card processor make more on a transaction than the retailer.

In 2018 the cost of convenience can be described as the cost of gaining access to the pre-existing payment network. From the perspective of the mathematics governing complex networks, a financial network and a data network are governed by the same rules of operation. Moreover, contracts, such as service level agreements, make the availability of the financial network and the data network functionally equivalent. However, unlike data networks, access to the financial network is typically made using one of many applications, all of which ultimately aggregate payments into a highly regulated (standardized) Federal Reserve System, yet none of which are standardized with each other due to their proprietary nature. Modern payment gateways are developed specifically for the purpose of easing the adoption of the proprietary standards imposed by the payment processor on commerce interfacing with the Federal Reserve.

Essentially, retail finds itself in a fight for its life using legacy products, built on legacy technology whose origins predate mechanical computing, and all of which costs more to operate than entire market segments can hope to profit. At the same time, virtually all transactions are sent as data over the application layer, and can ultimately be reduced to regular batches of spreadsheets that increasingly deviate from the Federal Reserve standards the further you are from the center of the network. Automated Clearing Houses (ACH) add a small amount of complexity, ACH member institutions, such as banks, add another small amount complexity, with each subsequent link in the chain doing the same, and no horizontal connections between chains. From a network perspective, it is a star pattern topology, optimized for centralized control and management by the Federal Reserve, and each link in the chain behaving like a faulty repeater.

In 1933 and 1934 this was considered state of the art and was dictated by the paper-based logistics chain required to track and process data. In 1998 it was discovered that complex networks spontaneously self-organize and have a scale-free topology that enables them to overcome entropy. Examples of complex networks are prolific in nature, and include social networks, the Internet, microbiology, academic citations, and the World Wide Web. As we have come to understand over the last twenty years, while a star pattern network makes sense from a logistics standpoint for the distribution of millions of pieces of paper a day, it is the hallmark of a network that is subject to scaling factors (such as distance and time), and the network can only grow at an ever diminishing return, i.e. the ever present entropy trap.

Current technological solutions being offered, such as crypto currency and blockchain, are at best misguided attempts to apply our scientific knowledge about complex networks in an effort to bypass the star network topology of the Federal Reserve Systems and Financial Institutions. Furthermore, while there are numerous competing technologies, there are only two ways to establish a universal standard, by fiat or by consensus. A fiat standard is adopted from the top down when the standard is mandated by a governing body, such as the United States dollar or TCP/IP (built on standards mandated by the Department of Defense in the 1960s and 1970s). A consensus standard is adopted from the ground up when a sufficient number of stakeholders agree to it, for example everyone using Google for searches. Moreover, these two methods of adoption are not mutually exclusive, a fiat standard must take into account stakeholder needs to thrive, and a consensus standard must eventually result in a fiat standard to thrive. All of these approaches seem to miss a fundamental understanding of the triumph of the American financial system, the American consumer; therefore it is currently impossible to establish the universal standard that is required.

We have known for the last 20 years that building network rules requires a ground up perspective if we are to accurately model network topology. In fact, the greatest attempts at understanding the American consumer have been social networks (like Facebook, Instagram, SnapChat, and Twitter) and group discount services like Groupon. At their core, each of these companies attempt to leverage the complex network benefits of our social networks as the foundation of a conversion funnel designed to drive traffic to the retailer by creating a pool of personal information that can be leveraged to increase the probability of a person transacting. Unfortunately, each of these companies are attempting to leverage the same social network, and as each has grown over the years we have found each of them are incapable of establishing a universal standard because each eventually is replaced by the next standard that has been designed to better match ever changing consumer expectations.

The efficacy of modern advertising that leverages social networks is still measured using traditional statistical mechanics as a means of quantifying the effects of marketing on consumer behavior. Unfortunately, as we have also known for 20 years, bell curves may accurately describe effects, but power law distributions accurately model the rules that determine the effect. Social networks, similar to the Internet and the financial system, are governed by the rules of complex networks, therefore a unified complex network model that can account for all three elements is capable of providing retailers with a predictive model ripe for automation.

### SUMMARY OF THE INVENTION

The present application provides a technological solution to overcome the technological problems of the prior art and represents an improvement in computer technology by providing a unified scale-free financial system that uses a distributed table for tracking devices, transactions, and clustering. Furthermore, a unified model will enable retailers to automatically adjust social clustering behavior in a similar manner to swarm technologies or swarm intelligence, allowing a seamless, continuously variable conversion funnel that always provides the exact amount of reward required to encourage beneficial group action. Even further, the present application provides for the integration of stored value. Above all else, doing so in a manner that eliminates false signals.

One aspect of the disclosure provides a method of value transmission in a network of clients, comprising: generating a value routing table and storing the value routing table at a first client; adding a first plurality of clients to the value routing table, a second client of the plurality of clients having a first mass representing a relationship between the first client and the second client; adding at least one event or subevent associated with first client to the value routing table at the first client, the at least one event or subevent having a second mass representing a relationship between the first client, the second client, and the at least one event or subevent; in response to receiving a value transmission request, preparing a value pool packet based at least in part on the first mass and the second mass; and completing a value transmission with the value pool packet.

### BRIEF DESCRIPTION OF THE DRAWINGS

The invention description below refers to the accompanying drawings, of which:

FIG. 1 is a system overview depicting the Value Transmission Protocol environment;

FIG. 2 is a diagram depicting the Token Index process;

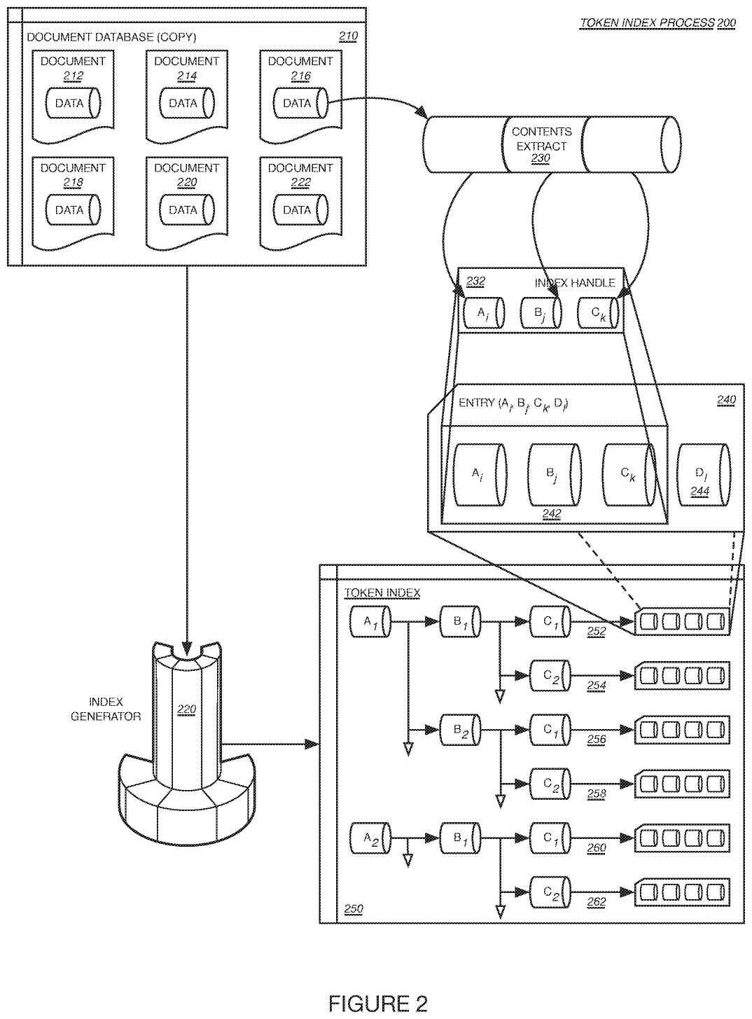

FIG. 3 is a flow chart depicting the method to generate the Token Index;

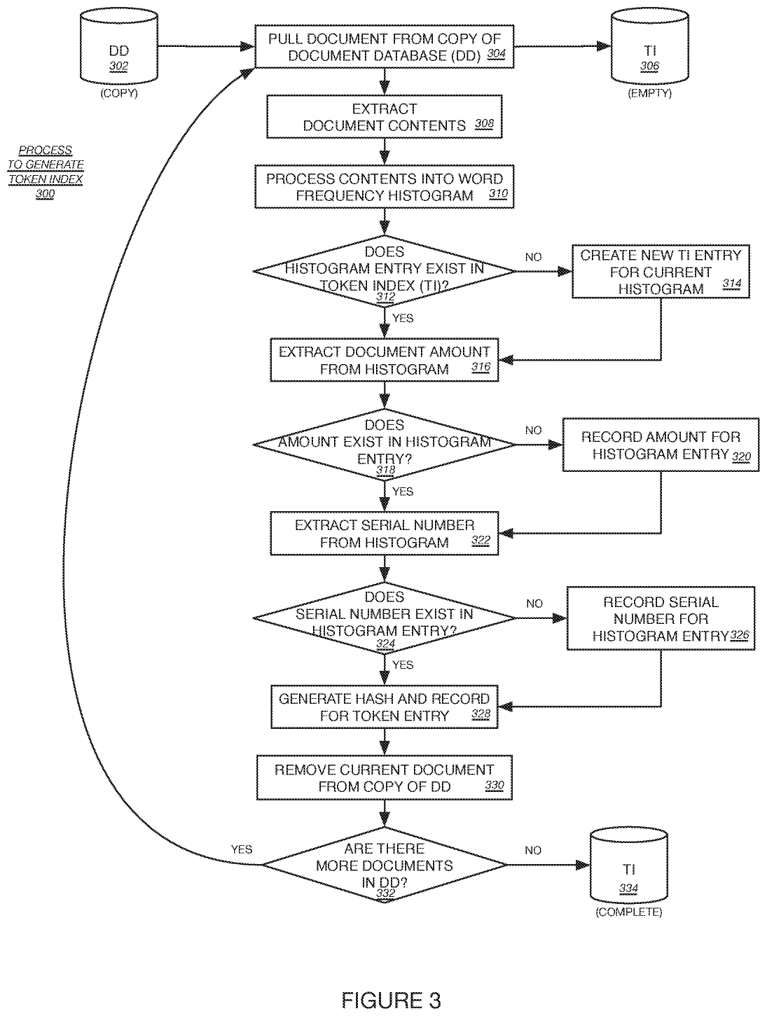

FIG. 4 is a diagram depicting the Value Transmission Protocol network;

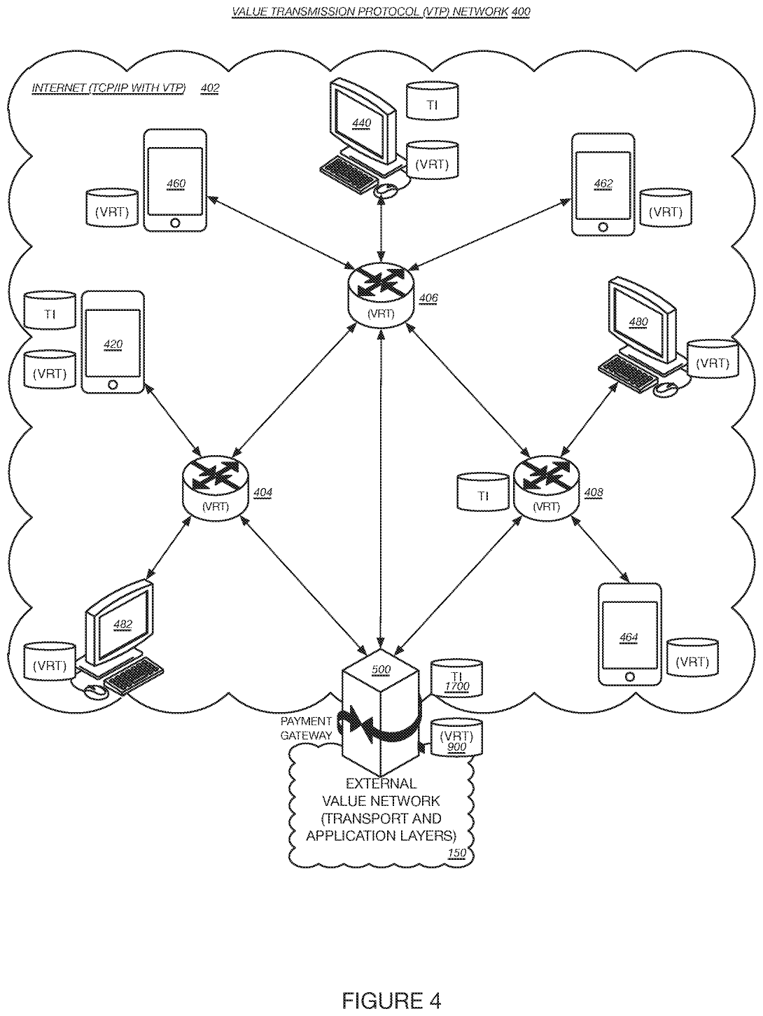

FIG. 5 is a diagram depicting the Payment Gateway router configuration;

FIG. 6 is a diagram depicting the VTP coded format;

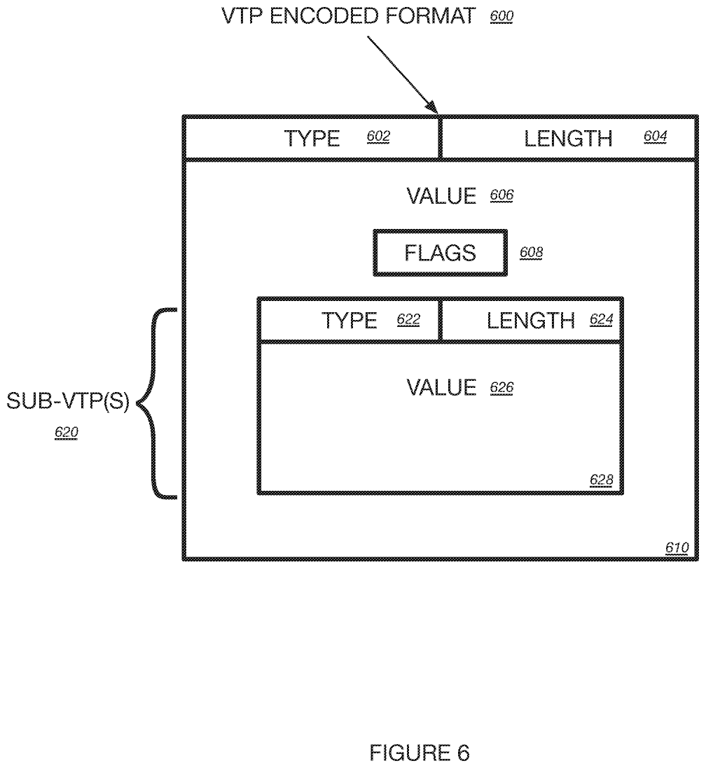

FIG. 7 is a diagram depicting the VT payload configuration;

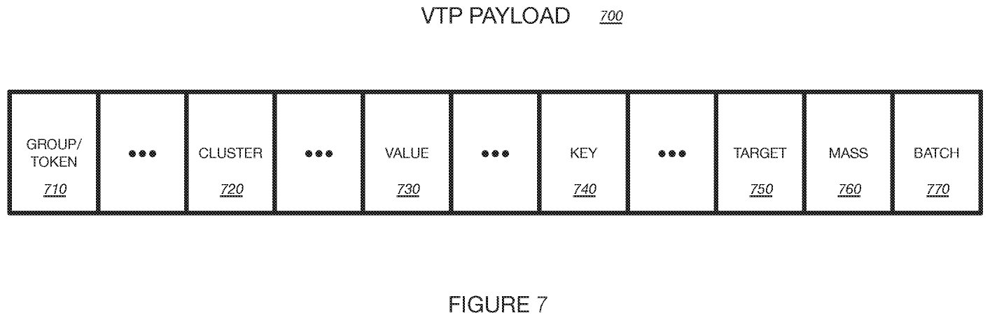

FIG. 8 is a diagram depicting the Value Routing Table configuration states;

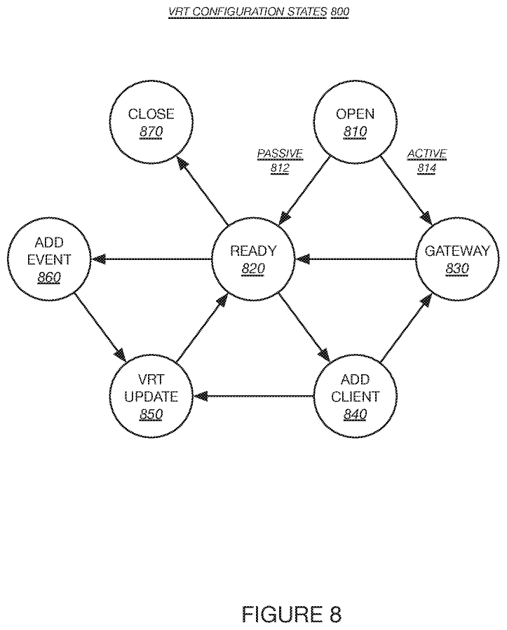

FIG. 9 is a diagram depicting the VRT Start configuration;

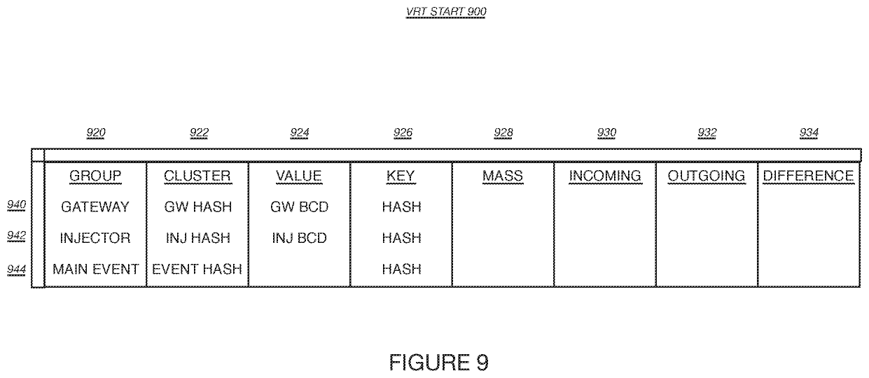

FIG. 10 is a flow chart depicting a method of the VRT Configuration Protocol;

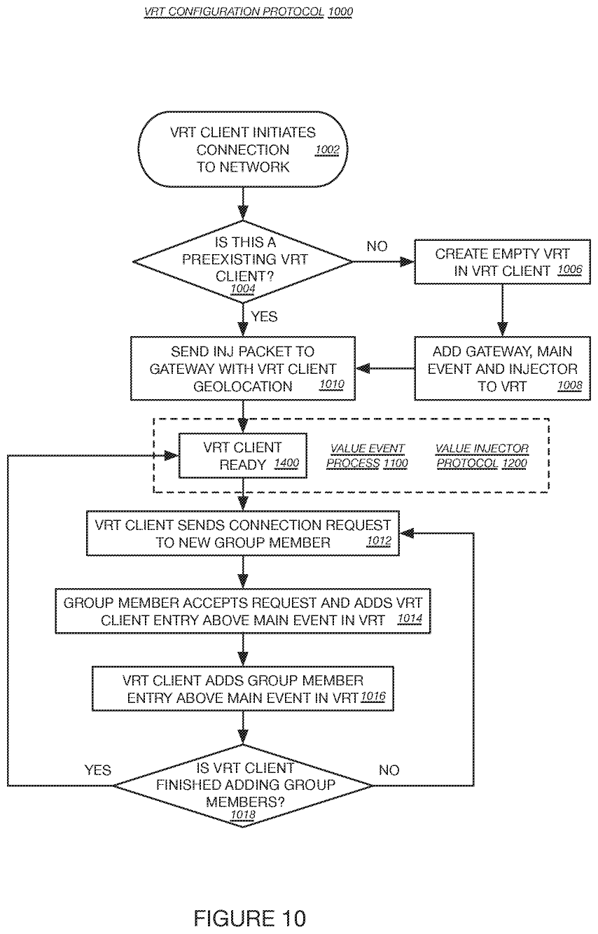

FIG. 11 is a flow chart depicting a Value Event Process;

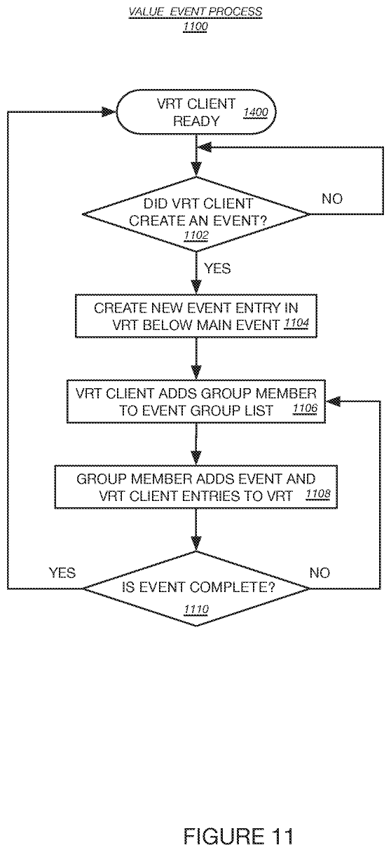

FIG. 12 is a flow chart depicting a Value Injector Protocol;

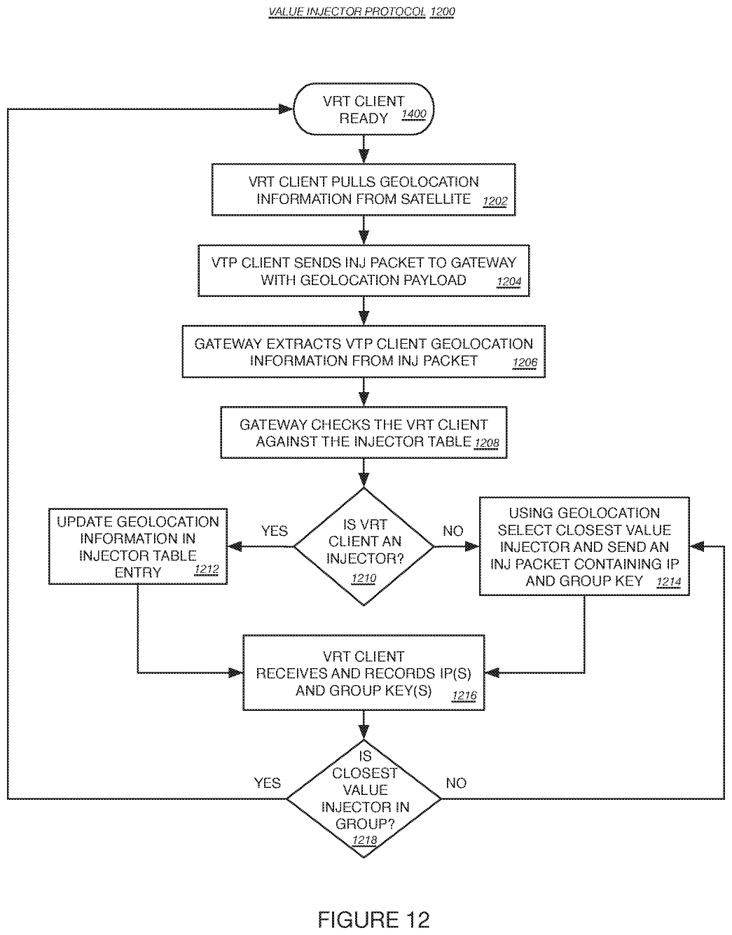

FIG. 13 is diagram depicting the Injector Table;

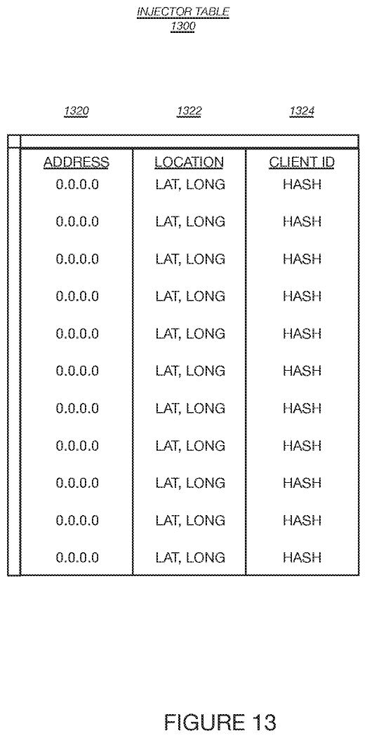

FIG. 14 is diagram depicting an example of a VRT ready state;

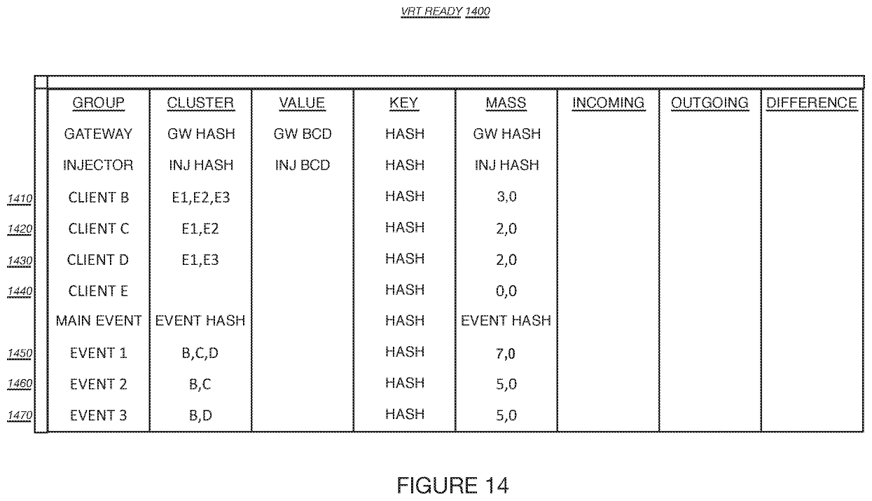

FIG. 15 is a flow chart depicting a Value Pool Protocol;

FIG. 15A is a flow chart further depicting the Value Pool Protocol of FIG. 15;

FIG. 16 is diagram depicting an example of a VRT ready state after establishing the VTP connection;

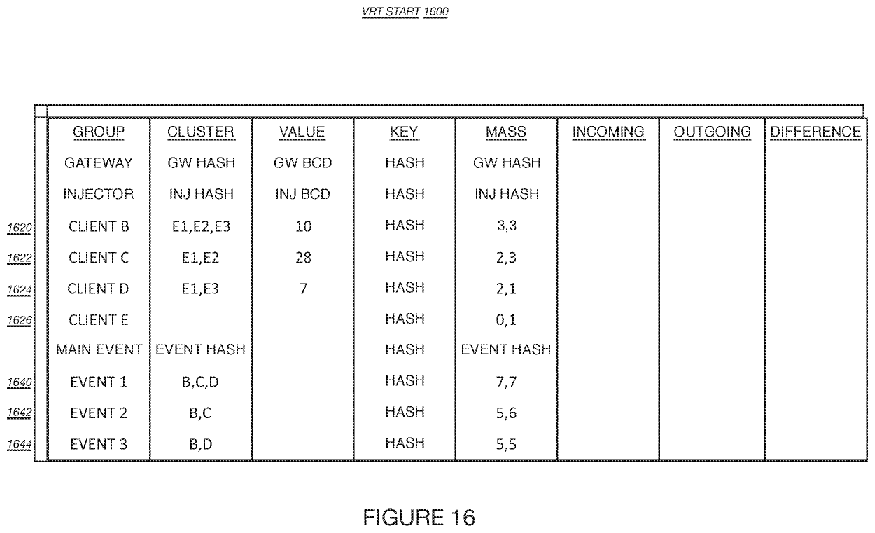

FIG. 17 is diagram depicting the VRT following the first example transaction;

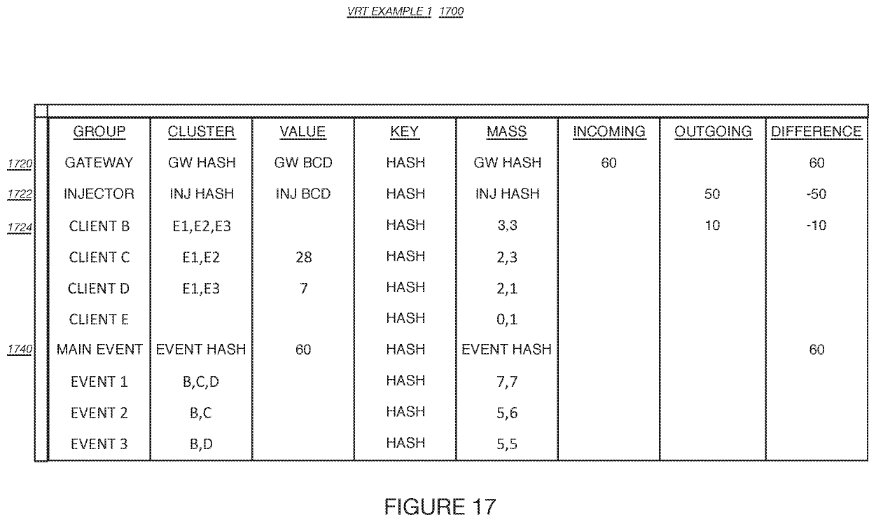

FIG. 18 is diagram depicting the VRT following the second example transaction, and demonstrates stored value;

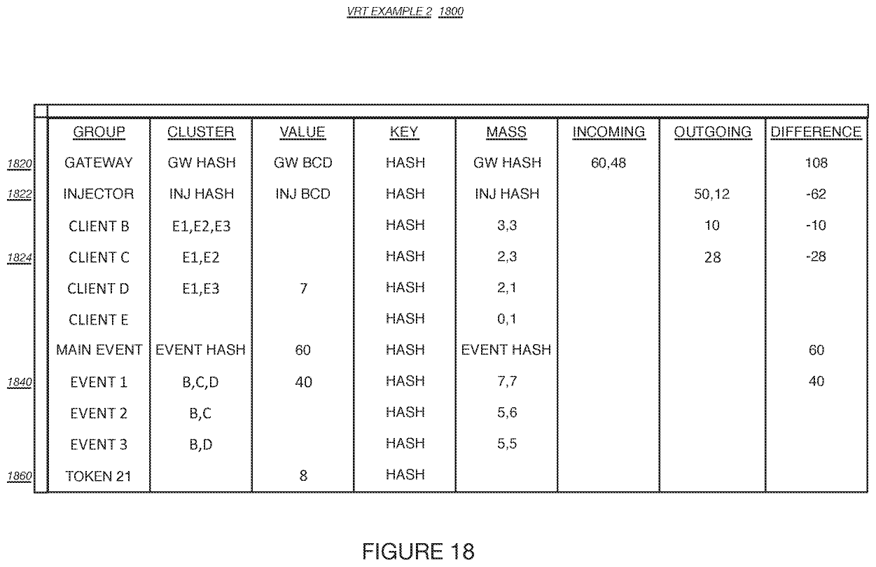

FIG. 19 is diagram depicting the VRT following the third example transaction, and demonstrates incoming value from an external payment network;

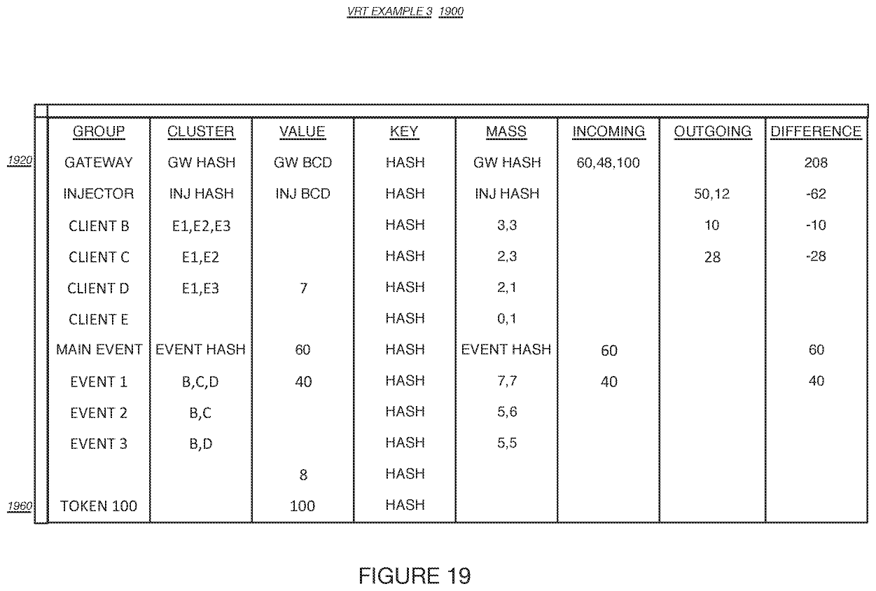

FIG. 20 is diagram depicting the VRT following the fourth example transaction, and demonstrates a transaction that includes both incoming value and stored value;

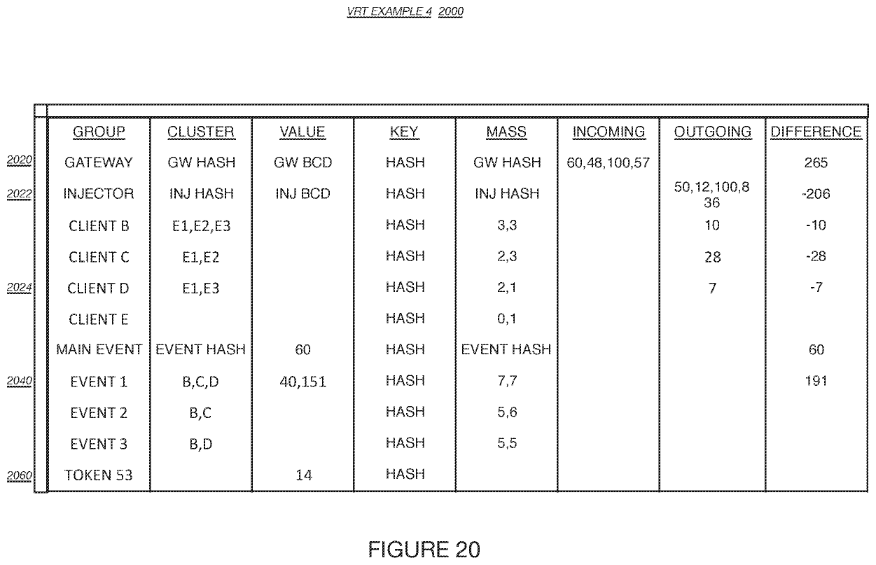

FIG. 21 is diagram depicting the VRT following the fifth example transaction, and demonstrates the stored value balance clearing function;

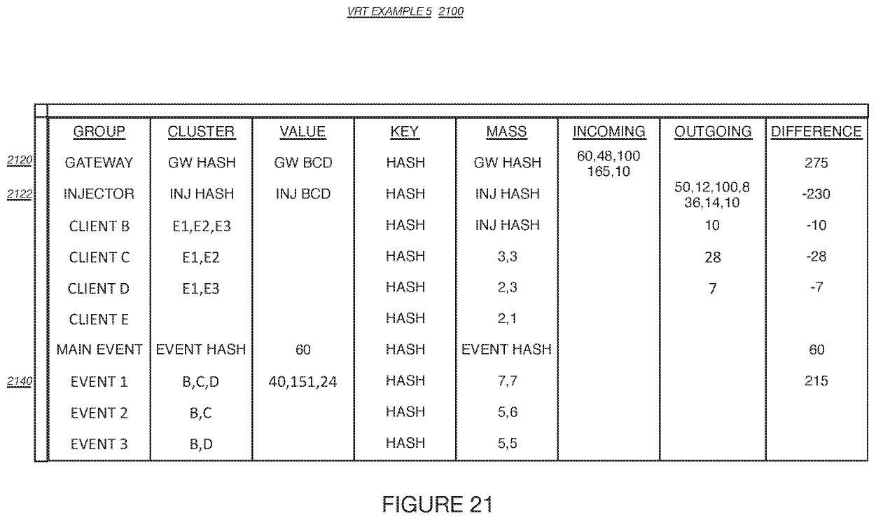

FIG. 22 is diagram depicting the starting state for the Value Injector VRT used in the examples;

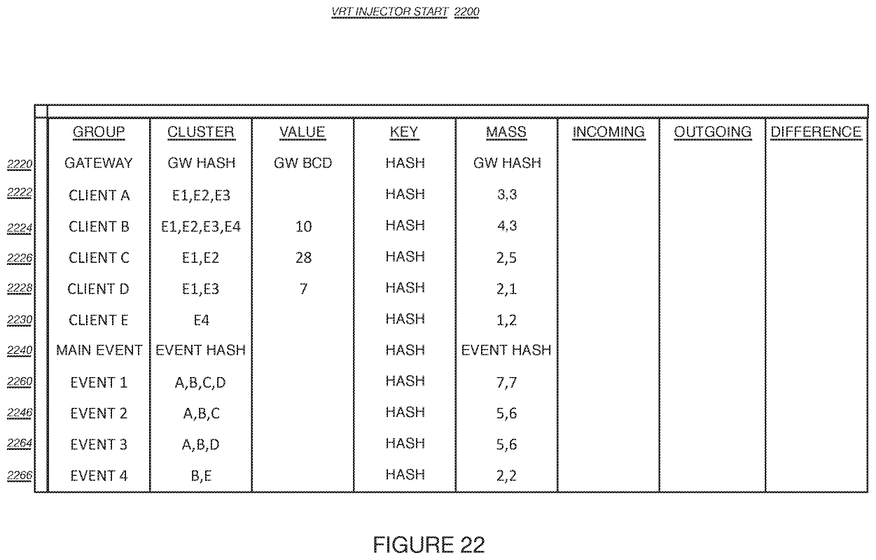

FIG. 23 is diagram depicting the starting state for the Token Index used in the examples;

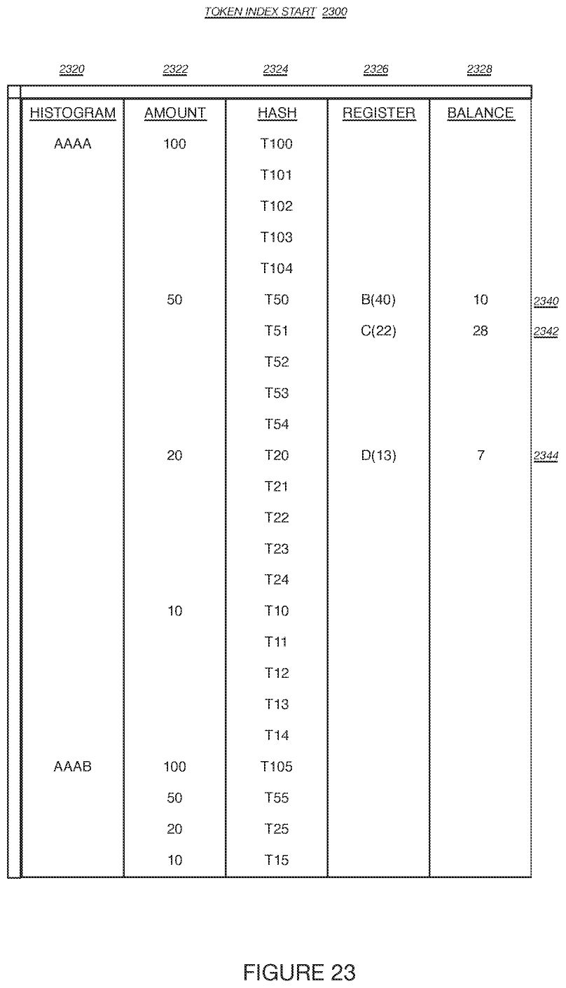

FIG. 24 is diagram depicting the final state for the Value Injector VRT used in the examples;

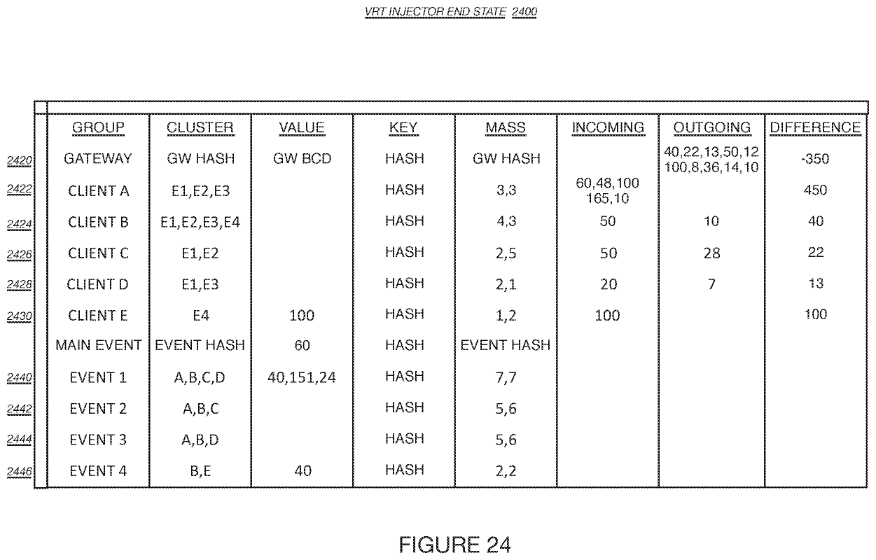

FIG. 25 is diagram depicting the final state for the Token Index used in the examples;

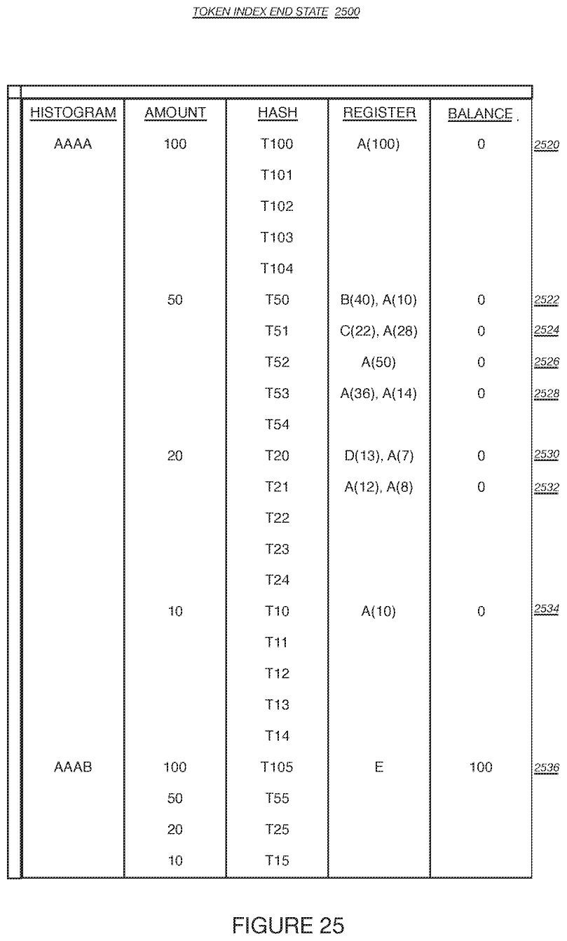

FIG. 26 is diagram depicting an example of the VRT for a Gateway with multiple Value Injectors;

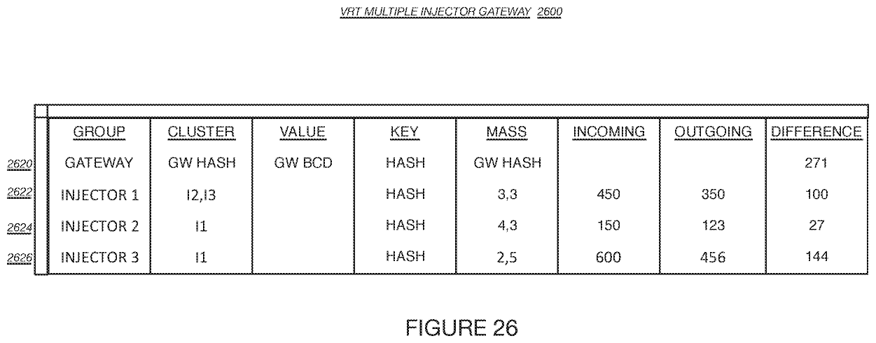

FIG. 27 is a flow chart depicting the Gateway Batch Protocol;

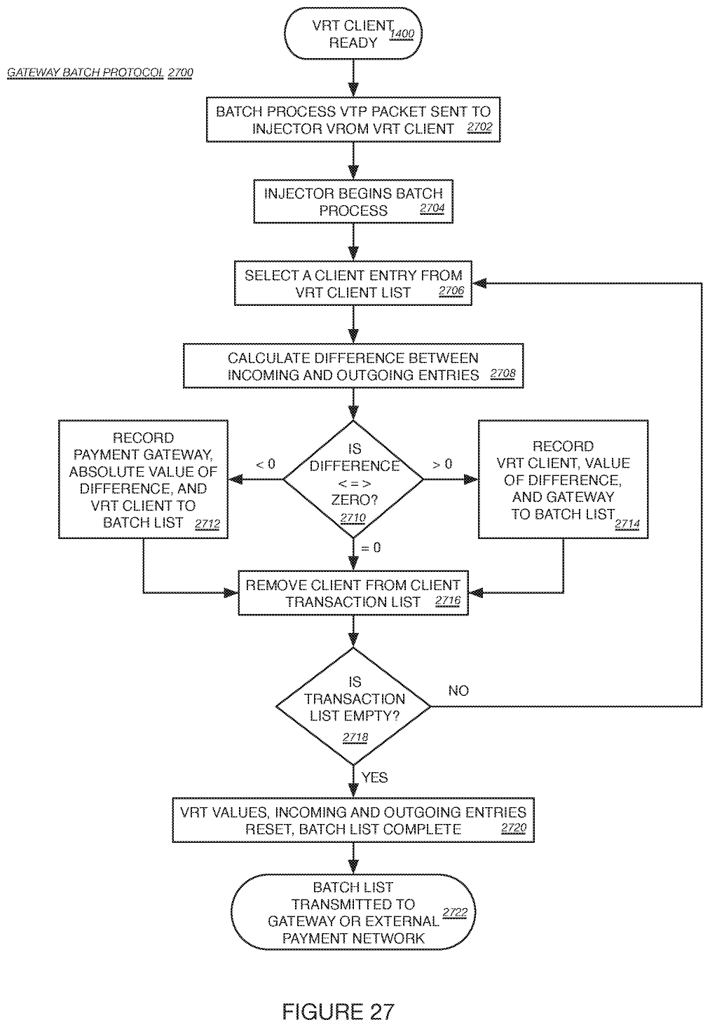

FIG. 28 is diagram depicting the Gateway Batch List for the Gateway in the examples; and

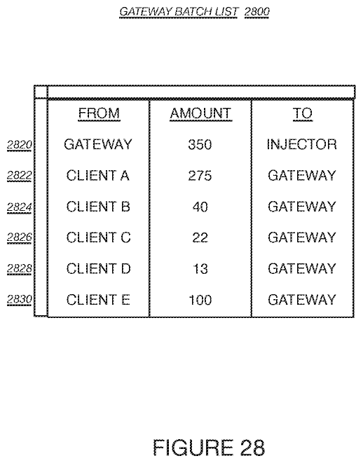

FIG. 29 is diagram depicting an example of a Gateway Batch List for a Gateway with multiple Value Injectors.

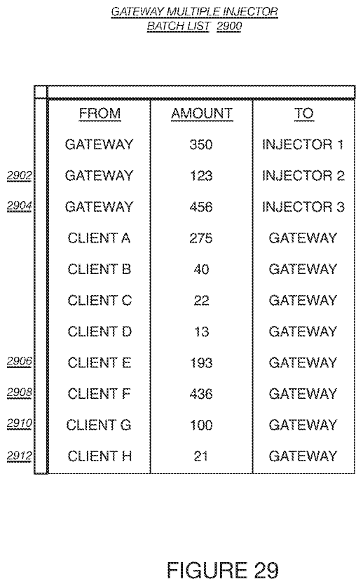

### DETAILED DESCRIPTION

The present application overcomes the disadvantages of the prior art by providing a system that establishes a scale-free unified theory for combining computer networks, payment networks, and social networks into as single, comprehensive model that incorporates pre-existing networks into an automated engine for establishing, maintaining, and controlling a self sustaining, failure-tolerant environment that operates at peak efficiency.

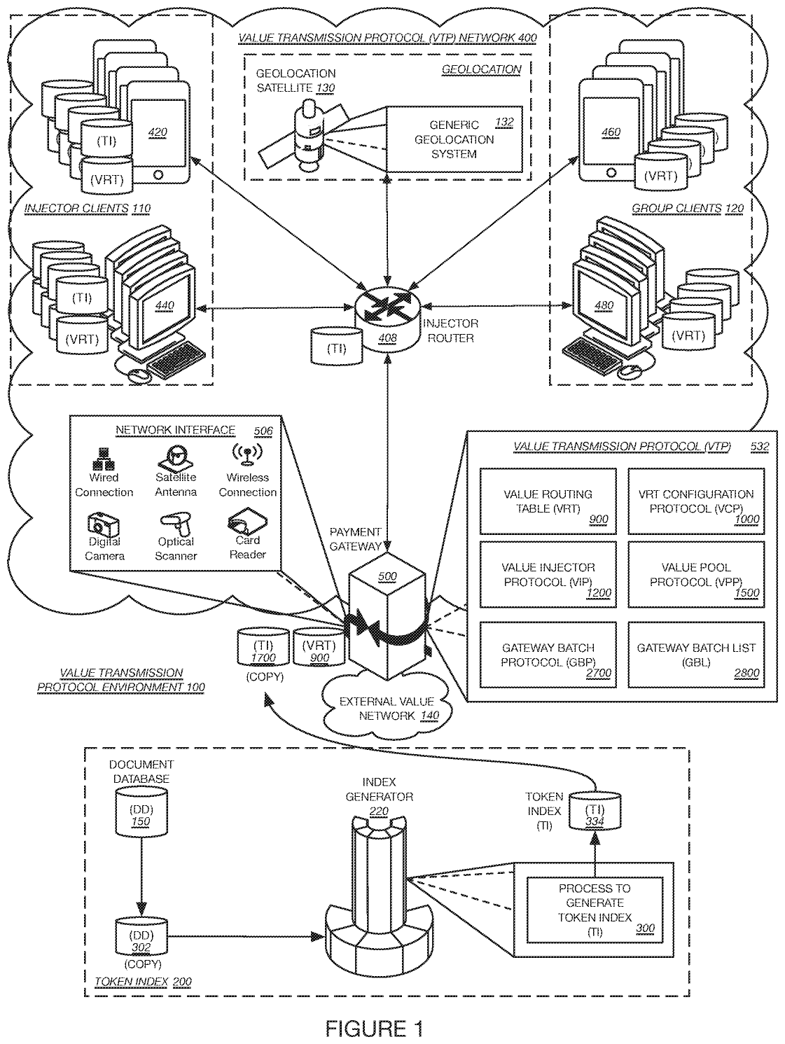

FIG. 1 is a schematic diagram showing a Value Transmission Protocol (VTP) Environment 100 that comprises a cloud of interconnected devices using the Value Transmission Protocol 400. The elements of the VTP Network are Value Injector Clients 110, Group Clients 120, a geolocation system 130, routers 408, a Payment Gateway 500 that connects the VTP network with an external value network 140, and a Token Index Process 200 that takes a Document Database 150 and creates a Token Index 1700 that is used as a transaction register by the Value Injector Clients 110, routers 408, and Payment Gateways 500.

Building on a pre-existing value network using the Token Index Process 200, a copy 302 is made of a document database 150 that consists of contracts for value. An index generator 220 then uses the Process to Generate a Token Index 300 to compile a token index 334, a copy of which is then placed in the memory of any Value Injector Clients 110.

It is envisioned that any type of computing device containing the Value Transmission Protocol 532 can serve as a Value Injector Client, including, but not limited to, one or more mobile devices 420 (e.g., mobile phones, tablets, etc.), one or more desktop computers 440, one or more routers 408, and/or the Payment Gateway itself 500. In this regard, the Value Transmission Protocol can be data and/or instructions stored locally or remotely with respect a storage medium associated with the computing devices. In one example, the Value Transmission Protocol 532 comprises at least six different components including the Value Routing Table 900, the VRT Configuration Protocol 1000, the Value Injector Protocol 1200, the Value Pool Protocol 1500, the Gateway Batch Protocol 2700, and the Gateway Batch List 2800. While six components are depicted, more or less than six components can be included in one or more implementations. In FIG. 1, devices containing the Value Transmission Protocol 532 are depicted with a Value Routing Table (VRT) 900, and comprise mobile devices (420 and 460), desktop computers (440 and 480), routers 408, and/or Payment Gateways 500. Devices connect to one another using a network interface 506, and can use a wired connection, wireless connection, satellite antenna, digital camera, optical scanner, card reader using a magnetic medium, or any other type of connection. Using a geolocation satellite system 130 (and the associated geolocation system 132) and the Value Injector Protocol 1200, the Payment Gateway 500 assigns Value Injector Clients 110 to Group Clients 120. In a retail environment, the Payment Gateways 500 can represent one or more servers operated by a company or retailer for the purposes of establishing and controlling a payment network, the Value Injector Clients 110 can represent cash registers (or other point-of-sale device configured to instantiate a transaction, such as a handheld device with point-of-sale software) at one or more stores, and Group Clients 120 can represent a mobile device (or one or more mobile devices) associated with a consumer or group of consumers.

The Token Index Process 200 is used to establish the value standard upon which the VTP 532 is built. The process starts with a copy of Document Database 210 containing standardized documents (212, 214, 216, 218, 220, and 222) the contents of which are data that contain legal contracts for value. In one example, the standardized documents can be contract terms for stored value, such as gift cards or gift certificates, but can also be any from of a written legal obligation for value that both parties are willing to accept for the exchange. The Index Generator 220 processes the Document Database 210 by selecting the first document entry in the database, and processing each document using the process described for Document 216, creating a Contents Extract 230 from the data contained within the document. The Contents Extract 230 is then processed into an Index Handle 232 consisting of elements Aᵢ, Bⱼ, and Cₖ, where Aᵢ is a word frequency histogram of the document contents that identifies who is issuing the contract and what the terms are, Bⱼ is the starting contract value, and Cₖ is either a serial number contained within the document, or a serial number supplied by the Index Generator 220. The Index Handle 232 is then converted to an Entry 240 by processing the Index Handle 242 using encryption techniques, such as Department of Defense encryption protocols MD5 or SHA, to generate a unique Hash 244 for each Entry. An example of the completed Token Index 250 demonstrates entries for multiple contracts values and serial numbers. The first four entries in the example (252, 254, 256, and 258) demonstrate a single contract with multiple values and multiple serial numbers per value. The last two entries in the example (260 and 262) demonstrate a single contract with different terms from the first contract containing one value with multiple serial numbers.

The process to generate the Token Index 300 is implemented by the Index Generator 220, and starts with creating a copy of the Document Database 302 (DD). The Index Generator first pulls a document from the copy of the Document Database 304, and then generates an empty Token Index 306. The Index Generator then extracts the document contents 308, and processes the contents into a word frequency histogram 310. Next the Index Generator determines if the word frequency histogram entry exists in the Token Index 312, if not it then creates a new Token Index entry for the current histogram 314. Once the histogram entry exists in the Token Index, the Index Generator extracts the document value from the document contents 316, and then determines if the document value exists in the histogram entry 318. If no, then the Index Generator records the value for the histogram entry 320. Once the value exists for the histogram entry, the Index Generator either extracts the serial number from the document contents 322, or in the alternative supplies a unique serial number, and it determines if the serial number already exists for the histogram and value 324. If no, the serial number is recorded for the histogram and value entry 326. Once this serial number exists for the histogram value entry, the Index Generator creates a unique hash and records the hash as the token entry 328. The Index Generator removes the current document from the copy of the DD 330, and then determines if there are more documents in the DD 332. If no, then the Token Index is complete 334 and the process ends. If yes, then the Index Generator pulls a document from the DD 304, and repeats the process until there are no more documents in the DD and the Token Index is complete 334.

The Value Transmission Protocol (VTP) Network 400 is comprised of a cloud of internet-enabled devices connected to each other using both TCP/IP and VTP 402. The devices can be any combination of mobile devices (420, 460, 462, and 464), desktop workstations (440, 480, and 482), routing equipment (404, 406, and 408), and one or more Payment Gateways 500 that connects to an external value network through both the transport and application layers 150. All VTP enabled devices contain a Value Routing Table 900 (VRT), and can be grouped as clients (460, 462, 464, 480, and 482), Value Injectors containing the Token Index 1700 (408, 420, 440, and 500), and a Payment Gateway 500. This example depicts multiple value injectors including the Gateway, however it is also envisioned that the gateway may or may not be a Value Injector, and is also envisioned that there be a single Value Injector that may or may not be the gateway.

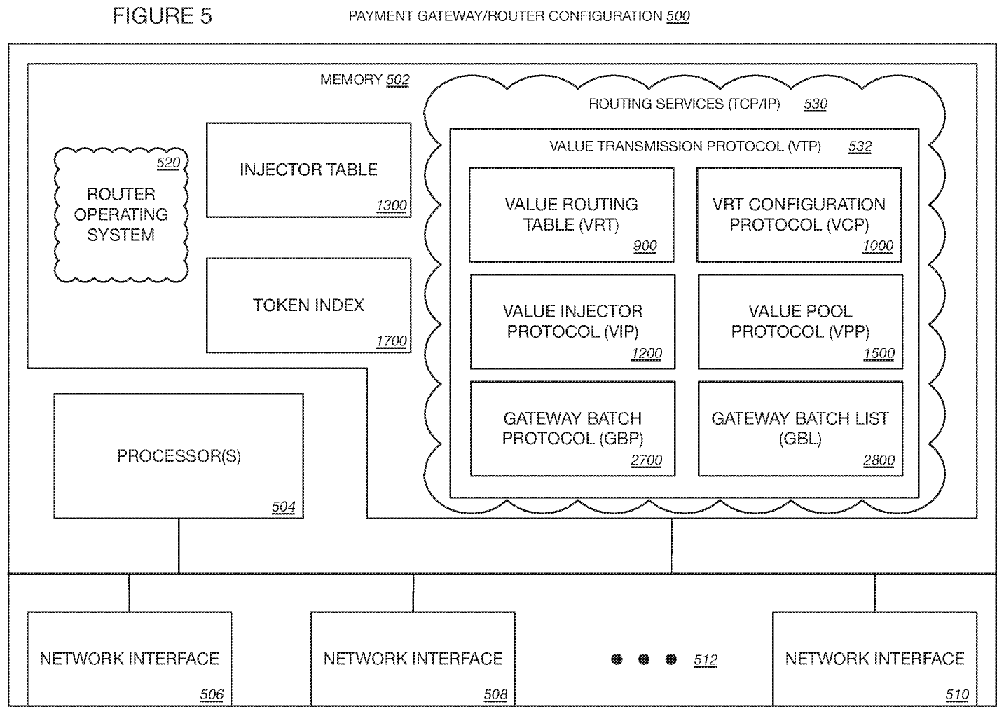

In FIG. 5, the Payment Gateway/Router configuration 500 comprises a device containing memory 502, one or more processor(s) 504, and one or more network interface devices (506, 508, 510, and 512). Stored within the memory 502 is a cloud-based router operating system 520, cloud-based routing services (TCP/IP) 530 including the Value Transmission Protocol (VTP) 532, an Injector Table 1300, and the Token Index 1700. VTP 532 consists of a Value Routing Table (VRT) 900, the VRT Configuration Protocol (VCP) 1000, the Value Injector Protocol (VIP) 1200, the Value Pool Protocol (VPP) 1500, the Gateway Batch Protocol (GBP) 2700, and the Gateway Batch List (GBL) 2800.

Data packets transmitted using the VTP data format 600 comprises a data packet 610 containing a header with fields for the packet Type 602, Length 604, a Value payload 606, and one or more Flags 608 that signify how the value 606 is processed by the device. The packet value 606 may contain one or more sub-VTP(s) with each sub packet 628 identified by its own type 622, length 624, and value 626. It is envisioned that the combination of flags 608 and VTP packets (610 and 620) can be used to trigger both single and multiple protocol processes simultaneously.

An example of the VTP data packet payload 700 structure consists of entries for one or more group/token(s) 710, cluster(s) 720, value(s) 730, and encryption key(s) 740 that are used to configure the Value Routing Table, a target value 750 and mass value 760 used for transactions, and a batch value 770 used for the Gateway Batch Protocol 2700.

A road map of the VRT configuration states 800 begins with the open state 810 from which a device (e.g., VPT-enabled device) can either start in passive mode 812 by waiting to receive incoming transmissions before transmitting to the network, or start an active mode 814 by transmitting to the network. Passive mode 812 leads directly to the ready state 820, while active mode 814 involves transmitting updated device information to the Gateway and network 830, which then transmit VRT updates to the device, upon receipt of which the device updates the VRT and enters the ready state 820. From the ready state 820 the device can enter the add client state 840, and once the client is added the VRT update state 850 the gateway/network update state 830 are both triggered. Upon completion of the VRT update state 850 and the gateway/network update state 830, the device enters the ready state 820. From the ready state 820 the device can also enter the add event state 860 during which sub events are created, after which the device enters the VRT update state 850, and then returns to the ready state 820. If there are no further VRT configurations from the ready state 820, the device configuration enters a close state 870 and is ready to transact.

For the purposes of illustration, an example of a VRT start 900 configuration demonstrates the possible values stored for each connected client, event, or token VRT entry (920, 922, 924, 926, 928, 930, 932, and 934), and for the three entries reserved for values related to the Gateway 940 (i.e. value pool selected for the transaction), the value injector 942 (i.e. point of sale system used for the transaction), and the main event 944 (i.e. group clients the client is connected to). Entry values for Group 920 may consist of IPv4 or IPv6 IP addresses for clients, event hashes, or token hashes. Cluster 922 values may include both reserved hashes for the Gateway, value injector and main event, and is also used as a clustering register for connected clients and events. Value 924 may include reserved values for the gateway and value injector, and is also used for recording the stored value connected clients and transaction amounts for each event. Key 926 is reserved for storing the unique cryptographic key used by each device or event when sending VTP information. Mass 928 is used for storing information related to clustering frequency and weight for connected clients and events, and is used for automatically (e.g. without user input) adjusting the reward a user receives for participating an event. Incoming 930 and outgoing 932 are used for storing the movement of value into and out of the VTP value pool, and difference 934 is used to store the net of incoming and outgoing values for each client in the VRT. The VRT Gateway entry 940 consists of an IP address or to group value 920 a reserve cache for cluster value 922 a reserve value (in this example a reserved Binary-Coded Decimal), and an encryption key 926. Similarly, the VRT injector entry 942 consists of an IP address, a reserved Hash, reserved value, and encryption key for the group 920, cluster 922, value 924, and key 926 values respectively. Finally the VRT main event entry 944 is used for recording values related to transactions that are not subject to any other event. Main Event values consist of a reserved hash for the Group 920 and Cluster 922 values, and empty value 924 used for recording all main event transactions, and a unique cryptographic key 926 that is used as the cryptographic key the VTP device uses to communicate securely with other connected clients. The Gateway 940 and injector 942 entries are for infrastructure and have no mass 928, while the main event 944 has a mass 928 that is the count of all connected clients recorded in the VRT. In this example there are no connected clients therefore the main event 944 would have no mass 928. For simplicity of description, the depicted VRT start 900 shows no connected clients and no transactions, therefore there are no incoming 930, outgoing 932, or difference 934 values stored for the gateway 940 or injector 942, in the main event 944 does not store values for the incoming 930, outgoing 932, or difference 934 values.

Using the VRT Configuration Protocol 1000, a VTP device configures the VRT for the purposes of facilitating transactions between clients connected to the VTP pool. The VRT Configuration Protocol starts when a VRT client initiates a connection to another device in the VTP network 1002. First, the VRT client determines if the client has a pre-existing VRT stored 1004. If not, the VRT client creates and stores and empty VRT 1006, and then adds the gateway, injector, and main event entries to the VRT 1008. Once the VRT is present, the VRT client sends an injector packet to the gateway containing the VRT client geolocation information 1010, and enters the VRT client ready state 1400. From the VRT client ready state the VRT client can add other VTP devices as group members to the VRT, and can also use the Value Event Process 1100 and the Value Injector Protocol 1200 to configure the VRT with events in addition to the main event, and is an injector or requires an injector for transactions. To add group members the VRT client sends a connection request to a new group member 1012, and the group member except the request and adds the VRT client entry above the main events in the group members VRT 1014. The VRT client has a group member entry above the main event in the VRT 1016 and then determines if the VRT client is finished adding group members 1018. If the VRT client adds additional group members then another new group member connection request is sent 1012, otherwise the VRT client returns to the ready state 1400.

The Value Event Process 1100 allows the VRT client to configure the VRT with main event (all of the connected group clients) and the sub events (events that reward coordinated group client behavior). Starting with the VRT client ready state 1400 the Value Event Process starts when the VRT client creates a new event 1102. The VRT client creates a new event entry in the VRT below the main event 1104. Next, the VRT client adds group member to the event cluster values 1106, and the group member adds the event in VRT client entries to the group member VRT 1108. Finally, the VRT client determines if the event configuration is complete 1110, and if not VRT client as another group 1 member to the event cluster values 1106 and repeats the process until the event is complete, at which time the VRT client returns to the ready state 1400.

The Value Injector Protocol 1200 allows for the configuration of VRT client injector entry and also allows value injectors to configure their VRT group member entries. Starting with the VRT client ready state 1400, the VRT client is a generic geolocation process, such as GPS, to determine the VRT client location 1202. The VRT client then sends an injector packet to the gateway with the geolocation payload 12 for, and the gateway extracts VRT client geolocation information from the injector packet 1206, and the gateway checks the VRT client information against the injector table 1208. Gateway determines if the VRT client is an injector by comparing the VRT client information against the entries in the injector table 1210. If the VRT client is not an injector then using the VRT client geolocation information the gateway selects the closest injector to the RT client and sends an injector packet containing the IP and encryption key values 1214, and the VRT client receives and records the IP and group key for the connected injector 1216. The VRT client is an injector then the VRT client's geolocation information is updated in the injector table 1212, and the VRT client begins receiving and recording IPs and group keys for non-injector VRT clients 1216, which are recorded in the injector's VRT in the same manner as group members in the VRT Configuration Protocol 1000. After the injector information is configured, the VRT client periodically sends an injector packet with geolocation information to the gateway, and the gateway determines if the closest value injector is configured for the VRT client. If not using the injector table the gateway selects closes injector and sends an injector packet with updated injector values 1214, otherwise the VRT client returns to the VRT client ready state 1400.

Stored on the Gateway, the Injector Table 1300 is composed of entries for each injector, with each entry storing values for the IP address 1320, geolocation 1322, and client ID 1324. Address values 1320 are typically stored in either 32-bit IPv4 or 64-bit IPv6 formats, location values 1322 are in the standard latitude and longitude format, and client IDs 1324 are stored as a hash that is a unique device identifier and may be generated using typical device fingerprinting techniques.

VRT ready state 1400 is provided as a hypothetical in which it is envisioned that the sub event group identifier can be comprised of information that determines how a formation operates and is rewarded by modifying the formation mass, which determines how well coordinated the formation's actions are. VRT that has been configured using the VRT Configuration Protocol 1000, Value Event Process 1100, and the Value Injector Protocol 1200. In this example, the VRT client has connected to four group members, client B 1410, client C 1420, client D 1430, and client E 1440 (client A is reserved for the subject VRT client). The example VRT also demonstrates that the subject client has added events (e.g., sub events) in addition to the main event, event 1 1450, event 2 1460, and event 3 1470. Client B has cluster values stored for events 1, 2, and 3, and the value count is recorded as a mass value of three (the additional mass value of zero is used to show that previous mass values may also be stored for determining event traction). Client C 1420 has cluster values stored for events 1 and 2 (1450 and 1460), resulting in a mass value of two, while Client D 1430 has cluster values stored for events 1 and 3 (1450 and 1470), also resulting in a mass value of 2. Client E 1440 has not joined any event other than the main event, resulting in a mass value of zero. Event 1 1450 has cluster value stored for Clients B, C, and D, and the mass is the sum of the masses for each client in the cluster, resulting in a mass value of 7. Events 2 and 3 both have two clients recorded in their cluster values, and their client mass sums coincidentally both result in mass values of 5 being recorded for each entry. For the sake of simplicity, the following examples will assume only one main event or sub event may be active at a time, however it is envisioned that an alternative embodiment using transaction numbers encoded with the target value instead of a simple target value will enable the main event and multiple sub events to be active simultaneously, allowing the mass modifiers to stack the rewards earned by the formation. Furthermore, for the purposes of illustration the following examples assume a legacy stored value system with preset denomination amounts, however it is envisioned that an alternative embodiment can bypass preset denominations by using an Injector that is capable of issuing exact change tokens, thus eliminating the need for a balance clearing mechanism.

Once the VRT is properly configured, the Value Pool Protocol 1500 allows the transmission of value between VRT clients for the completion of transactions. Starting from the VRT client ready state 1400, VRT client waits for a value transmission request 1502. Upon receipt of a value transmission request, the VRT client prepares a value pool packet 1504 by first determining if the VRT client has any tokens recorded in the VRT 1506. If there are no tokens in the VRT, the VRT client selects the group client with the highest value less than or equal to target value difference 1510. Otherwise, if the VRT client as tokens in the VRT, the VRT client calculates the difference between the token value sum and the target value 1508, and then the VRT client selects the group client with the highest value less than or equal to the target value difference 1510. The VRT client copies the group client value to the group client outgoing values and sets the group client value to zero 1512, following which the VRT client adds the target value, any token(s), group client, and the group client value to the value pool packet 1514. Next, the VRT client transmits the value pool packet to the value injector recorded in the VRT 1516, and then the VRT client deletes from the VRT all tokens used in the transaction 1518.

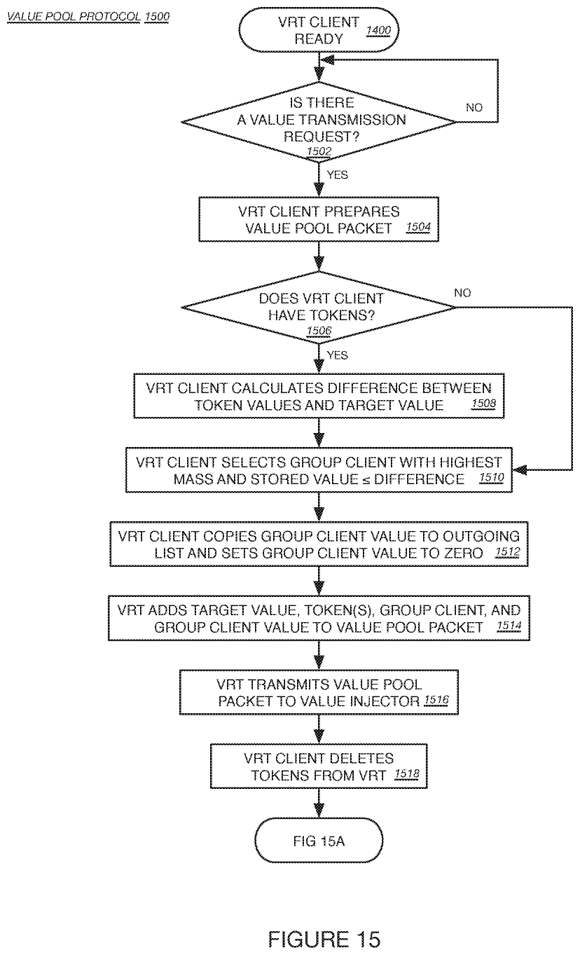

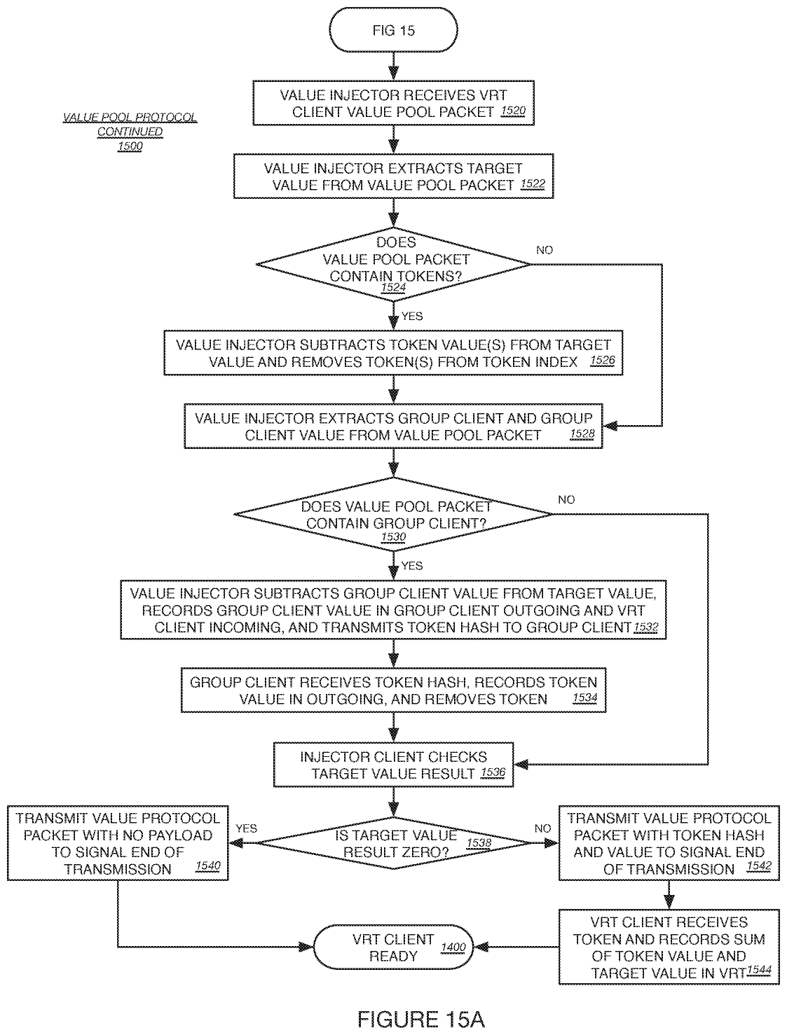

Continuing the protocol in FIG. 15A, the Value injector receives a VRT client value pool packet 1520, at which point the value injector extracts the target value from the value pool packet 1522. The value injector then determines if the value pool packet contains tokens from the VRT client 1524. If there are no tokens in the value pool packet, the value injector then extracts the group client group client value from the value pool packet 1528. However, if the value pool packet does contain tokens, then the value injector subtracts token value(s) from the target value and removes their respective token entries from the token index 1526, and then the value injector extracts the group client group client value from the value pool packet 1528. Next the value injector determines if the value pool packet contains a group client 1530, and if the packet does not contain a group client, the injector client checks the target value result 1536. The injector client determines the value pool packet contains a group client, first injector client subtracts group client value from the target value, records group client value in group client outgoing and VRT client incoming, and then transmits the token hash to the group client 1532, after which the group client receives the token hash, records the token value in the group client VRT outgoing entry for the injector client, and then removes the corresponding token from the group client VRT 1534. The injector client then checks target value result 1536, and determines if the target value result is zero 1538. If the target value result is non-zero, the injector client signals the end of transmission by sending a value pool packet to the VRT client containing a previously unused token hash and the difference between the token value and a target value 1542. Upon receipt of the value pool packet, the VRT client records the token hash as a group value at the bottom of the VRT entries, and then records the token value/target value difference for the transaction in the corresponding VRT token entry 1544, and then returns the VRT client ready state 1400. If the target value result is zero, then the injector client transmits a value pool packet with no payload to the VRT client as it means of signaling the end of transmission 1540, and then VRT client returns to the ready state 1400.

For the purposes of illustrating how the VRT works, building on the previous example VRT used to illustrate a sample VRT ready state 1400, sample data has been added to create a VRT start state 1600 upon which a series of example transactions are provided that demonstrate how transactions are recorded and how the balance clearing process operates. In these examples, injector clients (e.g., B-E) are assumed to have tokens with preset denominations of 10, 20, 50, in 100, however in other examples the preset denominations can be any whole or decimal value greater than or equal to zero, e.g., real numbers. Client C 1622 has a stored value of 28, a mass of 2 the next transaction, and a mass of 3 on the previous transaction. Client D 1624 has a stored value of 7, a mass of 2 for the next transaction, and a mass of 1 of the previous transaction. Client E 1626 has no stored value, a mass of zero for the next transaction, and a mass of 1 for the previous transaction. The main event, Event 1 1640, Event 2 1642, and Event 3 1644 have no transactions recorded, however Event 1 1640 has mass values of 7 and 7 recorded for the next transaction and previous transaction respectively. Event 2 1642 has mass values of 5 and 6 recorded for the current/previous transactions, and Event 3 1644 has mass values of 5 and 5 recorded for its current/previous transactions.

The first example transaction is for a transmission request with the target value of 60 and no tokens stored for the VRT client. VRT Example 1 1700 shows the target value of 60 being recorded as a value in the main event entry 1740 due to the main event being active. The VRT client has no token(s) stored; therefore the VRT client requires a value of 60 to enter the value pool, thus the value 60 is recorded as an incoming value for the gateway entry 1720, and the difference between the Gateway incoming and outgoing values is automatically calculated and recorded as a difference value of 60. Using the recorded group members stored values and mass, the VRT selects the group member with stored value that has the highest mass (in this example Client B). The VRT client updates the injector entry 1722 to reflect an outgoing value of 50, and the Client B entry 1724 is updated to show no stored value and an outgoing value of 10. The difference values for the injector entry 1722 and the Client B entry 1724 are automatically calculated and recorded for their respective entries.

The second example transaction builds off of VRT Example 1 1700, and is for a target value of 40 that occurs during Event 1 1840, and the target value and difference are recorded in the entry for Event 1. In this example the client with stored value and the highest mass is Client C 1824, so the VRT client updates the Client C stored value to zero, records the stored value 28 as outgoing value for Client C, and records the calculated difference. The difference between the target value and Client C's stored value is 14, so the injector client will need to add an uncirculated token for the lowest denomination that will be equal to or more than the target value difference, in this case a token with a 20 value denomination. To complete the transaction, the VRT client will require two tokens, one for value 28 from Client C and one uncirculated token for value 20, totaling a value of 48. The VRT client records a value of 48 in the Gateway entry 1820 and updates the difference. Next, the VRT client calculates the difference between the target value 40 and Client C's stored value of 28 for a result of 12, and the VRT client records the value 12 to the injector entry 1822 and also records the updated injector difference value. The Example 2 transaction results in a remaining balance of 8, so the injector transmits the hash for token 21 1860 that has the remaining stored value of 8. The VRT client records the hash for token 21 at the bottom of the VRT in the stored value of eight.

The third example transaction depicts the VRT client adding stored value of 100 to VRT example 3 1900. First, the gateway entry 1920 has 100 added to the gateways list of incoming values, and second and uncirculated token hash and value of 100 are added to the VRT as the entry for token 100 1960. Due to the fact that in this example the value is being stored, there is no corresponding value added to any of the events. Use of the stored value will be included in the target value on a future transaction.

The fourth example transaction is for a target value of 151 during Event 1, and uses multiple stored values from a group client and the VRT client, and is illustrated in VRT example 4 1900. Target value 151 is recorded in the entry for Event 1 2040, and the difference for Event 1 is also updated to 191. Next, the values for Token 21 1860 and Token 100 1960 are subtracted from the target value and removed from the VRT, giving a remaining target value of 43. In this example, Client D is the only group member with stored value, so the VRT client updates the Client D entry 2040 by removing the stored value of 7, and recording the outgoing value of 7 and the resulting difference is a remaining target value of 36. At this point, the remaining target value is 36, the injector client then determines that the least significant uncirculated token denomination greater than or equal to remaining target value, selects and uncirculated token value 50 and applies it to the remaining target value of 36. The difference between the remaining target value and the token denomination is 14, so the value injector transmits token 53 to the VRT client, the VRT client records the entry for token 53 2060 and the stored value 14. The token values used in the example transaction recorded in the injector entry 2022 as the values 100, eight, and 36. The target value of 151 and token 53 value of 14 combine for a total transaction amount of 165, and after subtracting the token values of 100 and 8 used by the VRT client, the amount of incoming value is recorded in the Gateway entry 2020 as the incoming value 57. All of the entry differences are updated accordingly.

The fifth example transaction is for a target value of 24 during Event 1 and depicts the use of VRT client stored value in a transaction with no remaining target value, and is illustrated using VRT example 5 2100. First, the target value of 24 is recorded in the values stored for Event 1 2140, and then the stored value of 14 previously recorded as token 53 2060 is removed from the VRT and the stored value is subtracted from the target value for a remaining target value of 10. The VRT client records the value 14 as an outgoing value in the injector entry 2122, and the value injector determines that the remaining target value of 10 is in an exact match to an uncirculated token denomination of 10. The VRT client records the value 10 as an incoming value in the Gateway entry 2120. At the finish of the fifth example all tokens have been cleared from the VRT, and the VRT client may still continue transacting.

For the purposes of illustrating how the injector client VRT and token index are used, the VRT injector start state 2200 and token index start state 2300 are provided for the example transactions above. The VRT injector start state 2200 and token index start state 2300 mirror the VRT start state 1600 from the VRT client. As the VRT injector does not require an injector entry, the only starting entries depicted are the gateway entry 2220 and main event entry 2240. In the VRT injector examples the entry for Client A 2222 represents the VRT client in the example transactions. The injector client also shows Event 4 2260, which is an event that Client A 2222 is not a member of, therefore Event 4 was not previously depicted in the VRT client examples 1700, 1800, 1900, 2000, and 2100. Client A's entry 2222 depicts clustering values representing the sub events Client A has joined. Entries for Client B 2224 and Client E 2230 depict additional cluster values for Event 4, and entries for Client C 2226 and Client D 2228 depict unchanged cluster values. Event entries for Events 1, 2, and 3 (2260, 2262, and 2264) depict the addition of Client A to their cluster values, and the entry for Event 4 2266 depicts the addition of cluster values for Client B and Client E. All mass values have been calculated and updated using the method previously described.

The token index start state 2300 depicts a simplified version of the token index that includes entry values for the word frequency histograms 2320, stored value 2322, token hash 2324, transaction register 2326, and remaining balance 2328. From the VRT start state 1600, we know that Client B has a stored value of 10, and this is depicted in the entry values for token T50 2340. Client C has a starting stored value of 28, and is depicted in the entry values for token T51 2342. Finally, Client D starts with a stored value of 7, and is depicted in the entry values for token T20 2344. The subsequent use of tokens is recorded in the token entry register values 2326, and tokens may be deleted when a token entry is used until the entry balance 2328 is zero, after which a token may never be used again.

Examples of the VRT Injector End State 2400 and Token Index End State 2500 depict both tables following VRT client examples 1700, 1800, 1900, 2000, and 2100. The VRT injector end state 2400 depicts outgoing Gateway values 2420 that are the aggregation of all outgoing injector values from the injector entry in each VRT client. Group client entries (2422, 2424, 2426, 2428, and 2430) depict the aggregation of all VRT client Gateway entries 2420 in each group client's respective incoming values. Additionally, the entry for Client E 2430 depicts the stored value of 100 has been added in a transaction not depicted in the example transactions. Similarly, all event entries (2440, 2442, 2444, and 2446) have had their target values recorded, and the entry for Event 4 shows a target value from a transaction not depicted in the example transactions. As depicted, to facilitate risk management, no token is ever used more than twice, however with additional layers of fraud prevention techniques, such as device fingerprinting, it is possible tokens maybe used more than two times. All mass values and difference values have been calculated using the methods described above.

The Token Index End State 2500 depicts updated register and balance values for token entries used in the examples (2520, 2522, 2524, 2526, 2528, 2530, 2532, 2534, and 2536). Token entries 2520, 2522, 2524, 2526, 2528, 2530, 2532, and 2534 depict tokens with zero balance, and may never be reused. Token entries 2522, 2524, 2528, 2530, and 2532 depict tokens with two recorded register values, while token entries 2520, 2526, and 2534 depicts tokens with a single recorded register value. Finally, token entry 2536 depicts the token used to provide Client E with a stored value of 100, however because the token has not been used to make a purchase there is no register value used stored with Client E, and the balance value is 100.

In the event the gateway and injector are separate devices, example of a VRT for a multiple injector gateway 2600 is provided for the purposes of illustration. In this example, three sample injector entries are depicted (2622, 2624, and 2626) for the purposes of demonstrating how the gateway monitors the size of the value pool. The VRT for a multiple injector gateway records the net pool value as the difference value in the Gateway entry 2620. The difference value for the gateway entry 2620 is calculated by taking the sum of the different values for the injector clients (2622, 2624, and 2626).

Periodically, the gateway transfers value into and out of the value pool using the Gateway Batch Protocol 2700. The Gateway Batch Protocol period can be set to automatically start using any combination of pre-established parameters such as time, valuable difference, or any other metrics. Manually initiating the Gateway Batch Protocol is also envisioned, but is not necessary. The Gateway Batch Protocol 2700 is automatically started by the VRT client from the VRT client ready state 1400 when a batch process VTP packet is sent to the injector from the VRT client 2702. Upon receipt of the batch process packet the injector begins the batch process 2704, by selecting a group client entry from the VRT 2706. The injector calculates the difference between incoming and outgoing values 2708, and then determines if the difference is greater than equal to or less than zero 2710. If the difference is less than zero, the injector creates a batch list entry for the client by recording values for the gateway ID, the absolute value of the difference, and the VRT client or injector 2712, after which the client is removed from the client transaction list. If the difference is greater than zero, the injector creates a batch list entry for the client by recording values for the client, the value of the difference, and the gateway ID 2714, and then removes the client from the client transaction list 2716. Finally if the difference is zero, then the client is removed from the client transaction list without recording anything in the batch list 2716. Once the client entry has been processed and removed the transaction list, injector determines if the transaction list is empty 2718. If there are entries remaining in the transaction list process repeats itself by selecting the next client entry from the transaction list 2706. If the transaction list is empty, then the injector and VRT client values, and incoming and outgoing entries are reset and the batch list is complete 2720. The batch list is then transmitted to the gateway or external payment network depending on whether or not the injector is the gateway, and if the gateway has multiple injectors 2722. If the injector is not the gateway or if the gateway has multiple injectors, then the batch protocol is repeated by the gateway until the batch list is complete and is transmitted to the external payment network.

For the purposes of illustration, a sample Gateway Batch List 2800 depicts the end result of the Gateway Batch Protocol 2700 in a configuration where the gateway and the injector are the same device. Entry values are formatted the first value being the source 2820, second value being the amount 2840, the third value being the recipient 2860. The first entry 2880 depicts an amount moving from the gateway to the injector, and represents the amount leaving the value pool to the injector as the injector earns stored value. Client entries (2882, 2884, 2886, 2888, and 2890) depict Clients adding stored value to the value pool for the purposes of completing a transaction.

In addition for the purposes of illustration, a sample Gateway Multiple Injector Batch List 2900 depicts the end result of the gateway compiling all of the injector batch lists. In this example, sample entries 2902 and 2904 have been added to include multiple injectors, and sample entries 2906, 2908, 2910, and 2912 have been added to include clients that have only transacted with the newly added injectors. As described above, the injectors and clients interact in the same manner as described for the simple Gateway Batch List 2800.

Based on the platform described above, it is now possible to describe how mass is used to drive the entire system. Mass is the number of connections between clients, and when mass is divided by the number of clients used in the mass calculation the result provides a density, which measures how closely coordinated group client behavior is with relation to a given client at the moment of value transfer. The present application advantageously automatically provides the precise reward required to encourage the coordinated behavior of the group clients and increases transaction size, frequency, and number of clients transacting.

Starting density provides a baseline level of group client coordination, and is calculated by taking the sum of the group client masses and dividing by the number of group clients in the VRT, the Main Event determines how well coordinated a VRT client with all of the connected group clients, and is calculated by taking the sum of the active user masses and dividing by the number of active users, and finally sub events help determine the group clients most coordinated with the VRT clients, with each dividing the modified sub event mass by the number of group clients in the sub event.

It is now possible to calculate the efficiency of the main event and sub events by dividing the event density by the starting event density, and then using the efficiency as a multiplier for determining exactly how well-coordinated the transaction is with regard to all of the connected group clients and how well coordinated the transaction is with the VRT Client's favorite group clients. By mapping rewards to the density of the participating clients, it becomes possible to automatically adjust the token exchange rate for every transaction. For example, a new client may require a special sub event reward of a highly favorable exchange rate for the purposes of encouraging the first transactions, but once the VRT client is transacting, the exchange rate is automatically adjusted by main event and sub events used in the density calculations so that efficient group client coordination is encouraged. Similarly, a retailer can adjust the revenue generated by using the exchange rate as a throttle that can change the amount of reward in real-time to the requirements of the retailer. It is envisioned that by including additional retailer data such as store profitability, or operating hours, an auto-throttle can be created that eliminates chaotic behavior, and maintains constant optimal efficiency for retailer operations (similar to cruise control using the optimal amount of fuel to maintain a constant speed).

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Note also, as used herein the terms “process” and/or “processor” and/or protocol should be taken broadly to include a variety of electronic hardware and/or software based functions and components. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software, consisting of a non-transitory computer-readable medium of program instructions, or a combination of hardware and software. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances of the system (e.g. 1-5 percent). Accordingly, this description is meant to be taken only by way of example, and not to otherwise limit the scope of this invention.

What is claimed is:

1. A method of value transmission in a network of clients, comprising:
generating a value routing table and storing the value routing table at a first client;
adding a first plurality of clients to the value routing table, a second client of the plurality of clients having a first mass representing a relationship between the first client and the second client;
adding at least one event or subevent associated with first client to the value routing table at the first client, the at least one event or subevent having a second mass representing a relationship between the first client, the second client, and the at least one event or subevent;
in response to receiving a value transmission request, preparing a value pool packet based at least in part on the first mass and the second mass; and
completing a value transmission with the value pool packet.

2. The method of claim 1, wherein at least one of the first client or the second client comprises a value injector.

3. The method of claim 2, wherein the value injector is in an active state or a passive state.

4. The method of claim 1, wherein the first mass represents a relationship between the first client and the first plurality of clients.

5. The method of claim 4, wherein the at least one event or subevent comprises a main event associated with the first client and the first plurality of additional clients.

6. The method of claim 1, wherein at least one of the first client or the second client comprises at least one of: a mobile device; a value injector; a desktop computer; a router; or a payment gateway.

7. The method of claim 1, wherein the value transmission request comprises a request with a target value.

8. The method of claim 7, wherein the target value is associated with the at least one event or subevent of the value routing table.

9. The method of claim 8, further comprising selecting a token from one of the first client or the second client having a highest mass.

10. The method of claim 7, wherein the target value comprises predetermined denominations.

11. The method of claim 1, wherein completing the value transmission with the value pool packet comprises transmitting the value pool packet to a value injector comprising at least one of the first client, the second client, or one or more additional clients.

12. A computing system comprising:
a memory storing instructions;
one or more processors executing the instructions to cause one or more of the processors to:
generate a value routing table and storing the value routing table at a first client;
add a first plurality of clients to the value routing table, a second client of the plurality of clients having a first mass representing a relationship between the first client and the second client;
add at least one event or subevent associated with first client to the value routing table at the first client, the at least one event or subevent having a second mass representing a relationship between the first client, the second client, and the at least one event or subevent;
in response to receiving a value transmission request, prepare a value pool packet based at least in part on the first mass and the second mass; and
complete a value transmission with the value pool packet.

13. The system of claim 12, wherein at least one of the first client or the second client comprises a value injector.

14. The system of claim 13, wherein the value injector is in an active state or a passive state.

15. The system of claim 12, wherein the first mass represents a relationship between the first client and the first plurality of clients.

16. The system of claim 15, wherein the at least one event or subevent comprises a main event associated with the first client and the first plurality of additional clients.

17. The system of claim 12, wherein at least one of the first client or the second client comprises at least one of: a mobile device; a value injector; a desktop computer; a router;
or a payment gateway.

18. The system of claim 12, wherein the value transmission request comprises a request with a target value.

19. The system of claim 18, wherein the target value is associated with the at least one event or subevent of the value routing table.

20. At least one non-transitory computer readable medium storing instructions that, when executed by one or more processors, cause the one or more processors to:
generate a value routing table and storing the value routing table at a first client;
add a first plurality of clients to the value routing table, a second client of the plurality of clients having a first mass representing a relationship between the first client and the second client;
add at least one event or subevent associated with first client to the value routing table at the first client, the at least one event or subevent having a second mass representing a relationship between the first client, the second client, and the at least one event or subevent;
in response to receiving a value transmission request, prepare a value pool packet based at least in part on the first mass and the second mass; and
complete a value transmission with the value pool packet.
